(19) United States
(12) Patent Application Publication
(10) Pub. No.: US 2026/0356307 A1
(43) Pub. Date: Nov. 12, 2026

(54) Fastening Device With Verifiable Assembly Position

(71) Applicant: Bayerische Motoren Werke Aktiengesellschaft, Muenchen (DE)

(72) Inventor: Markus SCHUHBAUER, Aschach an der Steyr (AT)

(21) Appl. No.: 19/481,048

(22) PCT Filed: May 2, 2024
(86) PCT No.: PCT/EP2024/062031

§ 371 Date: Nov. 3, 2025

(30) Foreign Application Priority Data
May 4, 2023 (DE) 10 2023 111 635.5

(51) Int. Cl. B60R 16/02; F16B 2/10; F16B 5/06

(52) U.S. Cl. CPC B60R 16/0215; F16B 2/10; F16B 5/0685; F16B 2200/95

(57) ABSTRACT

A fastening device includes a base portion and a cover portion. The fastening device has a closed state in which a form-fit connection is formed in regions between the cover portion and the base portion. At least on the cover portion or at least on the base portion a Radio Frequency Identification component, a so-called RFID chip, is arranged and is permanently connected in an electrically conductive manner at least to the base conductor or at least to the cover conductor. The cover portion has a cover contact region and the base portion has a base contact region for forming a selective electrically conductive connection between the cover conductor and the base conductor. The electrically conductive connection is established in the closed state of the fastening device and is broken in the open state.

### BACKGROUND AND SUMMARY

The disclosure relates to a fastening device, specifically a fastening clip, with a machine-readable and therefore verifiable assembly position. DE 10 2020 107 616 A1 also deals with a connection arrangement with an RFID chip that is machine-readable.

The disclosure is described below using a fastening clip for a motor vehicle; this should not be understood as limiting the disclosure to such an application. In a motor vehicle, a large number of lines are laid to conduct electrical current or to carry media. Such lines often have to be laid in a fixed position, and in some cases they are held in place by fastening clips. The fastening clip is connected to a structural component on one side and to the line on the other. During assembly of the motor vehicle, photographic images and image recognition can be used to attempt to detect whether the fastening clip has been installed correctly or incorrectly, although such optical detection can be difficult or impossible. If a fastening clip that is not correctly installed is not recognized as such, it may come loose during operation of the motor vehicle or release the line unexpectedly, which may lead to a loss of function in the operation of the motor vehicle. Against this background, the disclosure proposes a fastening device with improved verifiability of the assembly position. This problem is solved by a fastening device according to this specification, with preferred developments also being the subject of this specification.

For the purposes of the disclosure, a fastening device is understood to be a device for holding or fastening lines in a fixed position on a frame, preferably on a motor vehicle. Such a fastening device has a base portion with at least one anchor foot, wherein the anchor foot is designed to fasten the fastening device to a frame, in particular a component of a motor vehicle. The frame or component to which the fastening device can be fastened is not the subject of the disclosure. Preferably, this anchor foot has at least one anchor lug for forming a form-fit or friction-locking connection, preferably a so-called snap-in connection, with the component or frame.

Preferably, the anchor foot is designed to be inserted into a bore or recess. The fastening device further has a cover portion. The cover portion, together with the base portion, is designed to enclose a line, preferably a media line such as, in particular, a hose or pipe line, and further preferably an electrical line such as, in particular, a vehicle electrical supply system line or high-voltage line. Such a line, which is mechanically connected to the frame or component by the fastening device and thus held there, is not part of the present disclosure.

The fastening device has a closed and an open state. In the closed state, a form-fit connection is formed in some regions between the cover portion and the base portion; this form-fit connection is preferably achieved by a so-called snap connection. Furthermore, the base portion is connected to the cover portion in some regions in a hinge-like manner, and preferably the cover portion and the base portion are connected to each other in one piece in this region, and further preferably a living hinge is formed in this region between the base portion and the cover portion. In the closed state, the cover portion encloses a holding region with the base portion, wherein, in a planned installed state of the fastening device, a line, as described, is received in this holding region, in particular the base portion and the cover portion enclose this holding region, in which a line is received in the planned installed state of the fastening device.

Furthermore, when the fastening device is open, this form-fit connection between the base portion and the cover portion is released, or in other words, this form-fit connection is not formed when the device is open, and this holding region is therefore only enclosed in portions by the base portion and cover portion. Figuratively speaking, the open state of the fastening device is intended to allow a line that is to be held by the fastening device to be inserted into the fastening device; after the line has been inserted, the form-fit connection between the cover portion and the base portion is established, thereby enclosing the holding region between them (cover portion and base portion).

It is further proposed that the anchor foot has at least one anchor conductor, in particular such an anchor conductor being understood to be a conductor for conducting electrical current, preferably such an anchor conductor being designed as a conductor track or a current conductor and further preferably such an anchor conductor being accommodated in or on the anchor foot. Furthermore, the anchor foot preferably consists, at least substantially, of an electrically non-conductive material, preferably a plastic, and further preferably the anchor foot comprises such a non-conductive material as at least one component. It is further proposed that the base portion has a base conductor, in particular a conductor for conducting electrical current, preferably such a base conductor is designed as a conductor track or a current conductor and, further preferably, such a base conductor is accommodated in or on the base portion. Furthermore, the base portion preferably consists, at least substantially, of an electrically non-conductive material, preferably a plastic, and further preferably the base portion comprises at least one non-conductive material as a component.

It is further proposed that the cover portion has a cover conductor, in particular a conductor for conducting electrical current, preferably such a cover conductor is designed as a conductor track or a current conductor and, further preferably, such a cover conductor is accommodated in or on the cover portion. Furthermore, the cover portion preferably consists, at least substantially, of an electrically non-conductive material, preferably a plastic, and further preferably the cover portion comprises at least one non-conductive material as a component, and preferably the material of the cover portion and the base portion are identical.

It is further proposed that a radio frequency identification component, known as an RFID chip, be arranged at least on the cover portion or at least on the base portion. Such a component can be read out mechanically in a particularly simple and contactless manner, wherein such reading is based on a non-optical method, i.e., not on image recognition, and is therefore particularly stable and less susceptible to interference. The use of an RFID chip for identifying products and thus for assigning information to a product is generally known. Preferably, such an RFID chip can be read by machine if it is incorporated in a closed circuit and cannot be read by machine if such a circuit is not closed or is interrupted. This at least one RFID chip is, in particular depending on whether it is arranged on the base portion or the cover portion of the fastening device, permanently electrically connected, in particular directly connected, to at least the base conductor (insofar as this is arranged on the base portion) or at least to the cover conductor (insofar as this is arranged on the cover portion). Such an RFID chip can also be connected to several base conductors or several cover conductors; furthermore, the RFID chip can preferably be arranged between two base conductors or between two cover conductors with respect to an electrical circuit.

In addition, the cover portion has a cover contact region and the base portion has a base contact region. This cover contact region and this base contact region are designed to form a selectively electrically conductive connection with each other and thus between the cover conductor and the base conductor. When the fastening device is closed, the cover contact region contacts the base contact region, thus establishing the electrically conductive connection between the base conductor and the cover conductor when the fastening device is closed, whereas in the open state the cover contact region is separated from the base contact region and thus the electrically conductive connection between these regions is broken or does not exist when the fastening device is open. In a fastening device in an embodiment without further switching points for selectively interrupting the circuit, i.e., with only one switching point between the cover portion and the base portion, this RFID chip can then be read by machine when the fastening device is closed and thus the circuit in which the RFID chip is received is closed.

In particular, because an electrically conductive connection is established when the fastening device is closed and interrupted when it is open, the state of the fastening device (open/closed) can be read by machine by means of the RFID chip, so that the state (open/closed) of the fastening device can be detected without an optical process but is nevertheless machine-readable, and in particular, a fastening device can be provided which, due to the simple checking of the state of the fastening device, is particularly suitable for large-series products.

In a preferred embodiment of the disclosure, particularly with regard to the electrical interconnection of the elements, at least one so-called anchor switching point is provided between the anchor conductor and the base conductor to form a selective electrically conductive connection between this base conductor and this anchor conductor. There is no electrically conductive connection between this anchor conductor and this base conductor as long as the anchor switching point is open, and when it is closed, such an electrically conductive connection exists between this anchor conductor and this base conductor. With regard to the circuit in which the RFID chip is accommodated, this results in a circuit with at least two switching points for selectively establishing an electrically conductive connection; only when these two are closed can the circuit in which the RFID chip is accommodated be closed.

Preferably, such an anchor switch point has at least one movable anchor wing, which is further preferably arranged on the anchor foot and which is further preferably designed to form a friction-and/or form-fit connection in a recess in a component or frame. It is further preferred that the anchor wing is moved into an anchor position by inserting the anchor foot into the frame or component, thereby actuating or closing the anchor switch point. In particular, in such an embodiment of the disclosure, a mechanical check of the fastening device is possible not only with regard to whether it is closed, but also whether it is inserted into the frame or component. In particular, if the fastening device is not completely/correctly inserted into the component or frame, the anchor switch point is not closed and thus the circuit in which the RFID chip is located is open, so that it cannot be read by machine.

In a preferred embodiment of the fastening device, it has a further base conductor in addition to the base conductor, in particular resulting from the fact that the base conductor is structurally separated from the anchor conductor by this anchor connection point or anchor connection points in a manner that is not structurally. It is therefore further proposed that this at least one further base conductor is selectively electrically conductively connected to the anchor conductor by means of at least one further anchor switching point, insofar as this further anchor switching point is closed or not connected when this further anchor switching point is not closed. In terms of the electrical connection, this additional anchor switch point is therefore arranged between this additional base conductor and the anchor conductor to form a selective electrically conductive connection. Preferably, this additional anchor switch point is structurally similar or preferably identical to the anchor switch point and preferably also has an anchor wing. In particular, by providing at least one anchor switch point and preferably also the further anchor switch point, it is possible to monitor not only the state of the fastening device (open/closed) but also the installation situation (anchor foot inserted/not inserted) with the same RFID chip, thus enabling a particularly simple design of the fastening device.

Individual features and developments of the disclosure are explained in more detail below with reference to the figures, with combinations of features other than those shown also being possible in principle. In the drawings:

### BRIEF DESCRIPTION OF THE DRAWINGS

FIG. 1 is a sectional view of the fastening device;

FIG. 2 is a 3D representation of the fastening device in both the open and closed states; and

FIG. 3 is a schematic electrical circuit diagram of the fastening device.

### DETAILED DESCRIPTION OF THE DRAWINGS

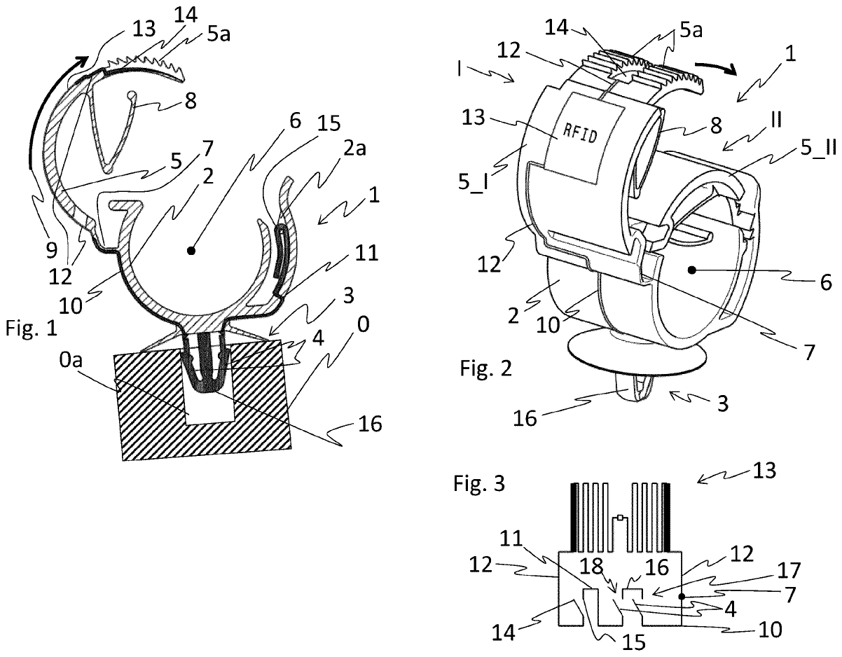

FIG. 1 shows a sectional view of a fastening device 1. The fastening device 1 has a base portion 2 with an anchor foot 3, wherein the anchor foot 3 is designed to fasten the fastening device 1 to a component 0 and is inserted into a fastening recess Oa for fastening, in which the anchor foot 3 clamps itself with the anchor wings 4.

The fastening device 1 further has a cover portion 5. The cover portion 5 is hinged relative to the base portion 2 so that the fastening device 1 is shown in its open state and the holding region 6 is not completely enclosed by the base portion 2 and cover portion 5. To form the form-fit connection between the base portion 2 and the cover portion 5, these each have latching regions 5a, 2a. Once the form-fit connection is established, the fastening device is in its closed state (not shown), and a form-fit connection is formed in some regions between the cover portion 5 and the base portion 2. Furthermore, the base portion 2 and the cover portion 5 permanently have a hinge-like connection in some regions, which is designed as a living hinge 7 or a living hinge 7a. When the fastening device 1 is closed, the cover portion 5 with the base portion 2, at least in the section plane shown, encloses the holding region 3 in the closed state. When the fastening device 1 is closed, the cover portion 5 with the base portion 2 completely encloses the holding region 6, at least in the section plane shown, so that a line (not shown) is held in place. The holding effect on the line is further improved by a hold-down device 8 which, when the fastening device is closed, presses a line received in the holding region 6 toward the base portion 2. To move the fastening device 1 from the open state, as shown here, to the closed state, with the cover portion 5 locked on the base portion 2, the cover portion 5 is moved relative to the base portion 2 in the folding direction 9. In the open state of the fastening device 1 shown, in which the form-fit connection between the latching regions 5a, 2a of the cover portion 5 and the base portion 2 is not formed, the holding region 6 is only enclosed in portions by the base portion 2 and the cover portion.

The anchor foot 3 has an anchor conductor, which in this case is provided with an electrically conductive coating; alternatively, it can be made of an electrically conductive material. Furthermore, the base portion 2 has a base conductor 10 and a further base conductor 11, and the cover portion 5 has a cover conductor 12. In addition to the cover conductor 12, an RFID chip 13 is arranged on the cover portion 5, which is permanently electrically conductively connected to the cover conductor 12, wherein the cover portion 5 has a cover contact region 14 and the base portion 2 has a base contact region 15 for forming a selective electrically conductive connection between the cover conductor 13 and the further base conductor 11, so that the selective electrically conductive connection is established when the fastening clip 1 is closed and is broken when it is open.

In other words, the anchor conductor 16, the base conductor 10, the cover conductor 12, the RFID chip 13 and the further base conductor 11, which is open when the fastening device 1 is in the open state and which is closed via the cover contact region 14 and the base contact region 15 when the fastening device 1 is in the closed state.

Furthermore, with reference to the electrical circuit between the base conductor 10 and the anchor conductor 16, or between the additional base conductor 11 and the anchor conductor 16 by means of the anchor wings 4, an anchor switching point 17 and a further anchor switching point 18 are formed, which are open (current circuit interrupted) if the anchor foot 3 is incorrectly inserted or not inserted into the fastening recess 0a. If the fastening device 1 with the anchor foot 3 is correctly inserted into the fastening recess Oa, the anchor wings 4 are deformed in such a way that the anchor switching points 17, 18 are closed and a current flow from the anchor conductor 16 to the base conductor 10 or to the further base conductor 11 is enabled.

FIG. 2 shows a three-dimensional representation of the fastening device 1, wherein both the open state I, with the cover portion in the open position 5_I, and the closed state II, with the cover portion in the closed position 5_II, are shown. When the cover portion is moved to the closed position 5_II, it encloses the holding region 6 with the base portion 2, in which a line is held in a fixed position when the fastening device 1 is mounted. A hold-down device 8 is also provided to fix the line in place. The anchor foot 3 with the anchor conductor 16 is arranged on the base portion 2. The fastening device 1 is mounted on a component in the planned mounted state via the anchor foot 3, as shown in FIG. 1. The base conductor 10 is arranged on the base portion 2 and is connected to the cover conductor 12 via the living hinge 7 or is formed integrally therewith, and furthermore an electrically conductive connection is thus established to the RFID chip 13, which is machine-readable. Furthermore, the RFID chip 13 is electrically conductively connected to the cover contact region 14 via the cover conductor 12, wherein the cover contact region 14 is arranged at the latching region of the cover portion 5a.

FIG. 3 shows a schematic electrical circuit of the fastening device. When the cover contact region 14 contacts the base contact region 15, the switching point between the base conductor 11 and the cover conductor 12 is established (fastening device is in the closed state). It can also be seen that in a case where the anchor wings 4 are pivoted into a closed position, and this position results from the correct assembly schematically shown in FIG. 1, the switching points between the anchor conductor 16 and the other base conductor 11 and the base conductor 10 are also closed (these are shown in the open position in FIG. 3). If all switching points are closed, the circuit via the RFID chip is closed and this can be read as a fastening device that is closed and correctly mounted. If at least one of the switching points is open, this circuit is interrupted and it can be detected automatically, in particular without an optical method, that the fastening device 1 is mounted incorrectly or that the fastening device 1 is not closed correctly.

In other words, it is already known to perform a visual or camera-based inspection of fastening clips that secure lines to body components in a motor vehicle. Such an inspection can be prone to errors, as it is difficult to use a camera in angled regions, especially in the engine compartment of a motor vehicle, not least because the contrast is poor there. Furthermore, a fastening clip to be inspected is often made of black plastic, making it difficult to detect small deviations in its closure/assembly condition. This can result in unnecessary rework because the fastening clip was correctly assembled after all, or in omitted rework because a fastening clip that was judged to be correct was not correctly assembled.

A basic idea of the disclosure is to provide a fastening device, in particular a fastening clip for a line, in which the mounting situation (mounting on a frame/component) and the closure situation are checked by means of a signal that is not optical but based on radio frequency technology, in particular by means of a so-called RFID chip.

One embodiment of the disclosure may therefore be to provide a fastening device designed as a fastening clip with an RFID chip attached to it, in particular glued to it. This RFID chip is open in the region of its antennas, in particular with respect to an electrical circuit in which it is integrated, in particular this refers to a fastening clip which is in an unmounted (not mounted as intended) and unclosed state. In this embodiment, current can only flow through the RFID chip when all contacts/switching points in the circuit of which this RFID chip is a component are closed. As long as the contacts/switching points are open, no electrical current can flow through the RFID chip and it cannot be read. The contacts or switching points in the circuit of which the RFID chip is a component are selected in such a way that they are closed when the fastening clip is correctly mounted and closed. Correct mounting of the fastening clip therefore closes all switching points and the RFID chip can be read by machine, as the circuit of which the RFID chip is a component is closed. This confirms that the fastening clip has been installed correctly. On the proposed fastening clip, the wires (base conductor, anchor conductor, additional base conductor, cover conductor) are inserted as electrical conductors or, preferably, molded from conductive plastic.

1.-3. (canceled)

4. A fastening device comprising:
a base portion with an anchor foot, wherein the anchor foot is configured to be mounted on a component, the anchor foot being configured to fasten the fastening device; and
a cover portion, wherein
the fastening device has a closed state in which a form-fit connection is formed in regions between the cover portion and the base portion,
the base portion is connected to the cover portion in a hinge-like manner in some regions,
the cover portion and the base portion enclose a holding region in the closed state,
the fastening device has an open state in which said form-fit connection is not formed and the holding region is only enclosed in portions by the base portion and the cover portion,
the anchor foot has an anchor conductor, the base portion has a base conductor, and the cover portion has a cover conductor,
at least on the cover portion or at least on the base portion a Radio Frequency Identification component, a so-called RFID chip, is arranged and is permanently connected in an electrically conductive manner at least to the base conductor or at least to the cover conductor,
the cover portion has a cover contact region and the base portion has a base contact region for forming a selective electrically conductive connection between the cover conductor and the base conductor,
the electrically conductive connection is established in the closed state of the fastening device and is broken in the open state.

5. A fastening device comprising:
a base portion with an anchor foot, wherein the anchor foot is configured to be mounted on a component, the anchor foot being configured to fasten the fastening device; and
a cover portion, wherein:
the fastening device has a closed state in which a form-fit connection is formed in regions between the cover portion and the base portion,
the base portion is connected to the cover portion in a hinge-like manner in some regions,
the cover portion and the base portion enclose a holding region in the closed state,
the fastening device has an open state in which the form-fit connection is not formed and the holding region is only enclosed in portions by the base portion and the cover portion,
the anchor foot has an anchor conductor, the base portion has a base conductor, and the cover portion has a cover conductor,
at least one of the cover portion or the base portion includes a Radio Frequency Identification component, an RFID chip, permanently connected in an electrically conductive manner at least to the base conductor or at least to the cover conductor,
the cover portion has a cover contact region and the base portion has a base contact region for forming a selectively electrically conductive connection between the cover conductor and the base conductor, and
the electrically conductive connection is established in the closed state of the fastening device and is broken in the open state.

6. The fastening device according to claim 4, wherein at least one anchor switching point is arranged between the anchor conductor and the base conductor for forming a selectively electrically conductive connection.

7. The fastening device according to claim 4, wherein the fastening device comprises at least one further base conductor, and further comprising: a further anchor switching point configured to form a selectively electrically conductive connection is arranged between the anchor conductor and the at least one further base conductor.
